(19) United States
(12) Patent Application Publication
(10) Pub. No.: US 2014/0205695 A1
(43) Pub. Date: Jul. 24, 2014

(54) Reinforced Thin Gage Tire Curing Bladder Mold Core

(71) Applicant: Benjamin P. Klisan, Uniontown, OH (US)

(72) Inventor: Benjamin P. Klisan, Uniontown, OH (US)

(21) Appl. No.: 13/871,352

(22) Filed: Apr. 26, 2013

Related U.S. Application Data
(60) Provisional application No. 61/755,530, filed on Jan. 23, 2013.

(51) Int. Cl. B29D 30/06

(52) U.S. Cl. CPC B29D 30/0645
USPC 425/49; 216/9; 409/131

(57) ABSTRACT

An improved tire curing bladder mold core that reduces the curing time otherwise required for a curing bladder and an associated tire, while also improving the overall strength of the relatively thin gauged tire curing bladder. The improved tire curing bladder mold core is comprised of an exterior surface with CNC milled or chemically etched patterns of grooves that result in the formation of elevated support ribs in the internal surface of the tire curing bladder. A method of producing an improved tire curing bladder mold core is also disclosed.

### CROSS-REFERENCE

This application claims priority from Provisional Patent Application Ser. No. 61/755,530 filed on Jan. 23, 2013.

### BACKGROUND

Tire curing bladder molds are well known in the art and are useful in the manufacture of many different types of tires. Most tire curing bladder molds are comprised of a mold core and two mold halves that surround the mold core, thereby creating a mold cavity for receipt of a tire curing bladder. It is also well known in the art to include chemically etched patterns along the interior surface of the two mold halves. These chemically etched patterns are typically in the form of elevated ribs which rise above the interior surface of the mold halves and are used to form grooves along a portion of the exterior surface of the tire curing bladder. The grooves provide channels for air to escape from between the bladder and the green tire during the curing process, and reduces the amount of tires that will need to be scrapped because they were not properly cured.

Furthermore, oftentimes there is an additional pattern formed in between the elevated ribs for camouflaging minor imperfections in the resulting tire. Nonetheless, both the elevated ribs and the additional patterns that appear between the elevated ribs result in recesses in the exterior surface of the tire curing bladder. These recesses typically have sharp corners and are known to weaken the structural integrity of the tire curing bladder, and can lead to premature tire failure. One way to compensate for this reduced structural integrity of the tire curing bladder is to use tire curing bladders with thicker walls. However, tire bladders with thicker walls require additional material which, in turn, increases manufacturing cost and is therefore undesirable.

Consequently, there exists in the art a long-felt need for a device and/or method of manufacture that improves the structural integrity of tire curing bladders. There also exists in the art a long felt need for a device and/or method of manufacture that minimizes gage thickness for tire curing bladders, and that reduces the curing times for both the tire curing bladders and the associated tires. Finally, there is a long felt need in the art for a device and/or method of manufacture that accomplishes all of the forgoing objectives, and that is relatively inexpensive to manufacture, and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, is an improved tire curing bladder mold core that facilitates the creation of elevated support ribs along the interior surface of a tire curing bladder. The support ribs improve the structural integrity of the tire curing bladder, thereby enabling the same to have a thinner gage. Thinner gauged tire curing bladders require less material and translate into lower manufacturing costs. The improved tire curing bladder mold core is preferably comprised of a core portion and a register portion, wherein the exterior surface of the core portion has a plurality of grooves therein. The grooves are used to form elevated ribs along the internal surface of the tire curing bladder, thereby improving the structural integrity of the tire curing bladder while also minimizing gage thickness. By minimizing the gage thickness of the tire curing bladder, the curing times associated with both the tire curing bladders and the associated tires are also reduced thereby improving manufacturing efficiency.

In a preferred embodiment of the present invention, the grooves are formed in the exterior surface of the core portion though milling and/or chemical etching, though other manufacturing processes known in the art for forming grooves or etchings in a metal surface are also contemplated such as burning, grinding and the like. The grooves are preferably formed in a pattern that is repeated along at least a portion of the exterior surface of the core portion. As described more fully below, various groove patterns are contemplated to be within the scope of the present invention.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates an elevational view of one embodiment of the improved tire curing bladder mold core's exterior surface with grooves formed therein in what is referred to as a brick pattern.

FIG. 1A is an example of the pattern depicted in FIG. 1.

FIG. 2 is a close-up elevational view of a portion of the grooves depicted in FIG.

FIG. 2A is a close-up view of an alternative embodiment of the grooves depicted in FIG. 2.

FIG. 3 illustrates an elevational view of one embodiment of the improved tire curing bladder mold core's exterior surface with grooves formed therein in what is referred to as a circle pattern.

FIG. 3A is an example of the pattern depicted in FIG. 3.

FIG. 4 illustrates an elevational view of one embodiment of the improved tire curing bladder mold core's exterior surface with grooves formed therein in what is referred to as a diamond pattern.

FIG. 4A is an example of the pattern depicted in FIG. 4.

FIG. 5 illustrates an elevational view of one embodiment of the improved tire curing bladder mold core's exterior surface with grooves formed therein in what is referred to as a grid with “X” pattern.

FIG. 5A is an example of the pattern depicted in FIG. 5.

FIG. 6 illustrates an elevational view of one embodiment of the improved tire curing bladder mold core's exterior surface with grooves formed therein in what is referred to as a polygon pattern.

FIG. 6A is an example of the pattern depicted in FIG. 6.

FIG. 7 illustrates an elevational view of one embodiment of the improved tire curing bladder mold core's exterior surface with grooves formed therein in what is referred to as a square pattern.

FIG. 7A is an example of the pattern depicted in FIG. 7.

FIG. 8 illustrates an elevational view of one embodiment of the improved tire curing bladder mold core's exterior surface with grooves formed therein in what is referred to as a triangle pattern.

FIG. 8A is an example of the pattern depicted in FIG. 8.

As previously stated, the patterns appearing in the various FIGS. are but a few representative samples of the vast number of different patterns that can be employed. Additionally, the curing bladder mold core's exterior surface may have random grooves formed or etched therein without a pattern.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details.

The improved tire curing bladder mold core and method of manufacture of the present invention facilitates the creation of elevated support ribs along the interior surface of a tire curing bladder. The support ribs improve the structural integrity of the tire curing bladder, thereby enabling the same to have a thinner gage. Thinner gauged tire curing bladders require less material and translate into lower manufacturing costs. Finally, the improved tire curing bladder mold of the present invention is relatively inexpensive to manufacture and safe and easy to use.

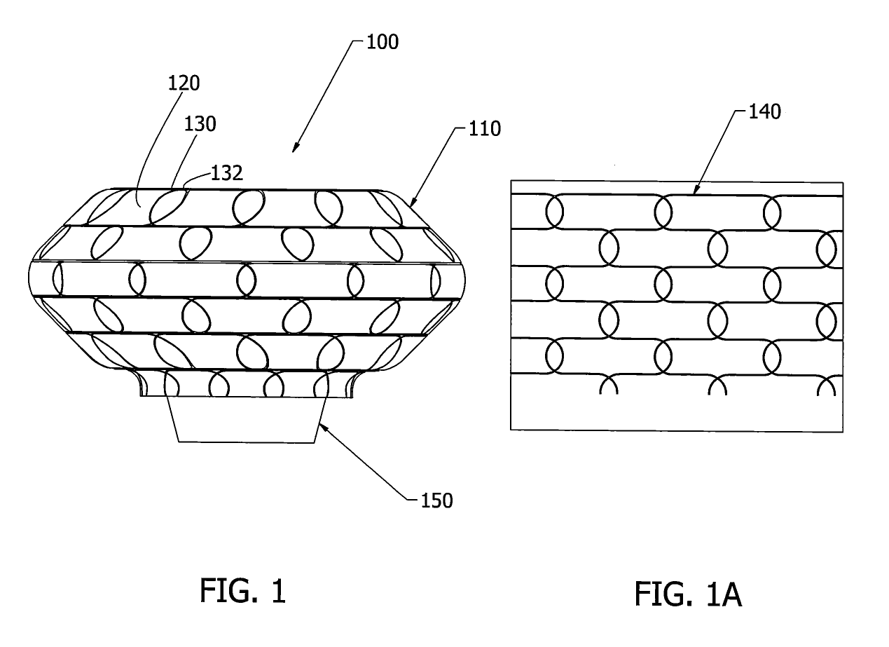

Referring initially to the drawings, FIG. 1 illustrates an elevational view of one embodiment of the improved tire curing bladder mold core 100 of the present invention which is preferably comprised of a core portion 110 and a register portion 150, wherein said core portion 110 is further comprised of an exterior surface 120. Mold halves (not shown) are typically used in conjunction with a tire curing bladder mold and surround the same to create a cavity for receipt of a tire curing bladder (also not shown). Core portion 110 and register portion 150 may be of unitary construction or comprised of separate components fixedly attached to one another. Nonetheless, the overall structure and function of each of core portion 110 and register portion 150 are well known in the art.

Notwithstanding the forgoing, one important aspect of the present invention is the formation of a plurality of grooves 130 in the exterior surface 120 of core portion 110. Grooves 130 are used to form elevated ribs (not shown) along the internal surface of the tire curing bladder (also not shown), thereby improving the structural integrity of the tire curing bladder and minimizing the gage thickness required to avoid premature tire and/or bladder failure. By minimizing the gage thickness of the tire curing bladder, the manufacturer is also able to reduce the curing times associated with both the tire curing bladders and the associated tires and improve manufacturing efficiencies.

In a preferred embodiment of the present invention, grooves 130 are formed in at least a portion of the exterior surface 120 of core portion 110 though milling, such as CNC milling, and/or chemical etching, though other manufacturing processes known in the art for forming grooves in metal are also contemplated. Grooves 130 are preferably between 0.02 and 0.6 inches deep, as measured from the bottom 132 of groove 130 to the exterior surface 120 of core portion 110, and comprise a radius 134 of between 0.03 and 2 inches. Nonetheless, it is contemplated that other dimensions could also be employed to suit user preference or a particular application. Further, it will be appreciated by one of ordinary skill in the art that the overall depth and shape of grooves 130 will approximate the overall height and shape of the corresponding elevated ribs (not shown) formed in the internal surface of the tire curing bladder (also not shown), thereby improving the structural integrity of the tire curing bladder and minimizing the gage thickness required to avoid premature tire and/or bladder failure.

Moreover, grooves 130 are preferably formed in a pattern 140 that is repeated along at least a portion of the exterior surface 120 of core portion 110. It is contemplated that there are countless different patterns 140 of grooves 130 that could be employed, and only a few are listed below as examples. For example, FIG. 1 illustrates an elevational view of one embodiment of the improved tire curing bladder mold core's exterior surface 120 with grooves 130 formed therein in what is referred to as a brick pattern 140. A stand alone example of said pattern 140 also appears immediately to the right of said elevational view of the improved mold core 100.

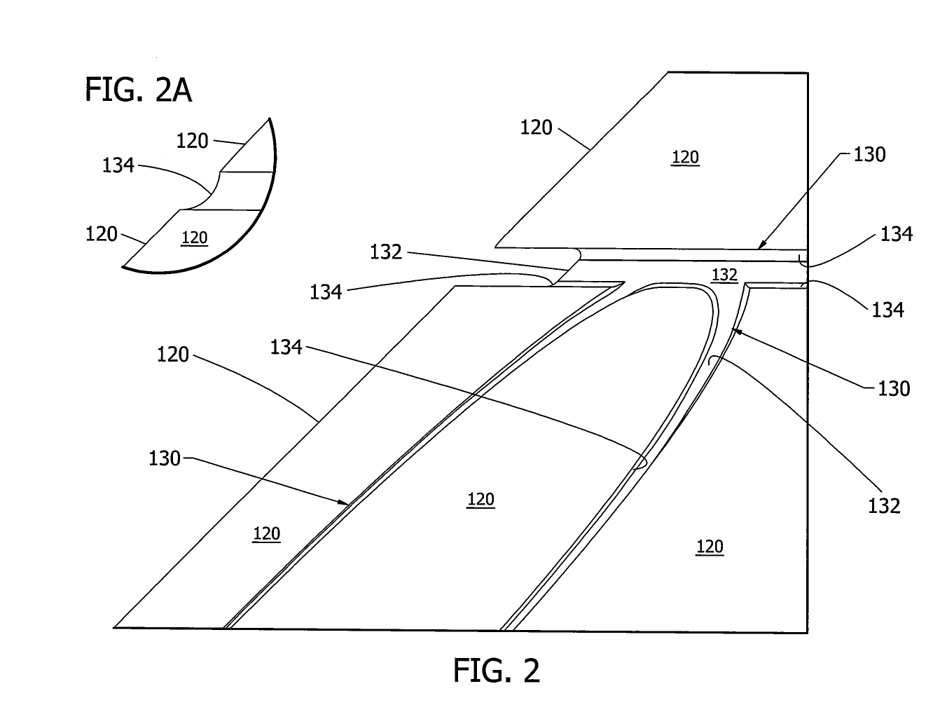

FIG. 2 is a close-up elevational view of a portion of the grooves depicted in FIG. 1, and FIG. 2A is a close-up view of an alternative embodiment of the grooves depicted in FIG. 2 wherein said groove is more rounded.

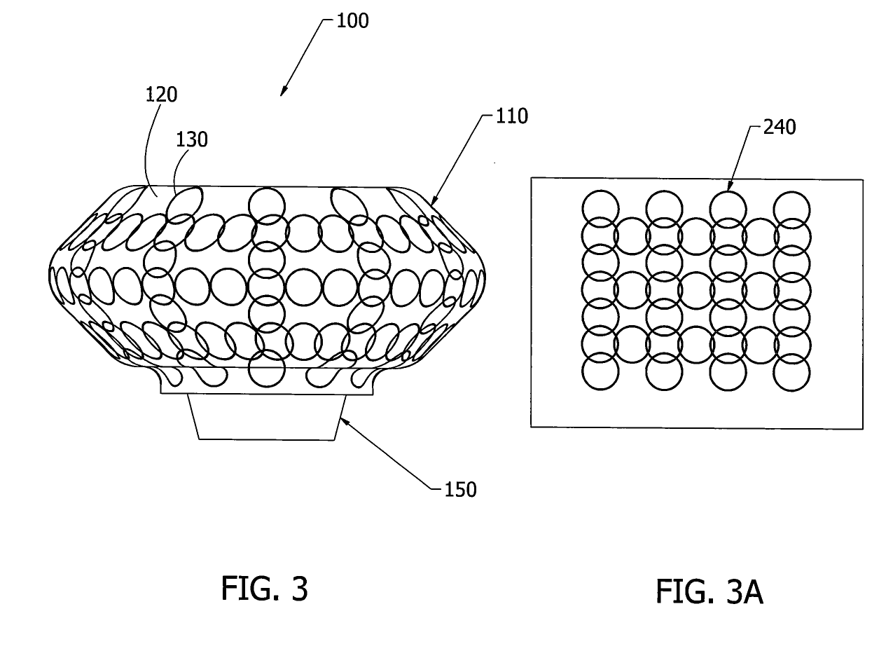

FIG. 3 illustrates an elevational view of an alternative embodiment of the improved tire curing bladder mold core's exterior surface 120 with grooves 130 formed therein in what is referred to as a circle pattern 240. A stand alone example of said pattern 240 also appears immediately to the right of said elevational view of the mold core 100 in FIG. 3A.

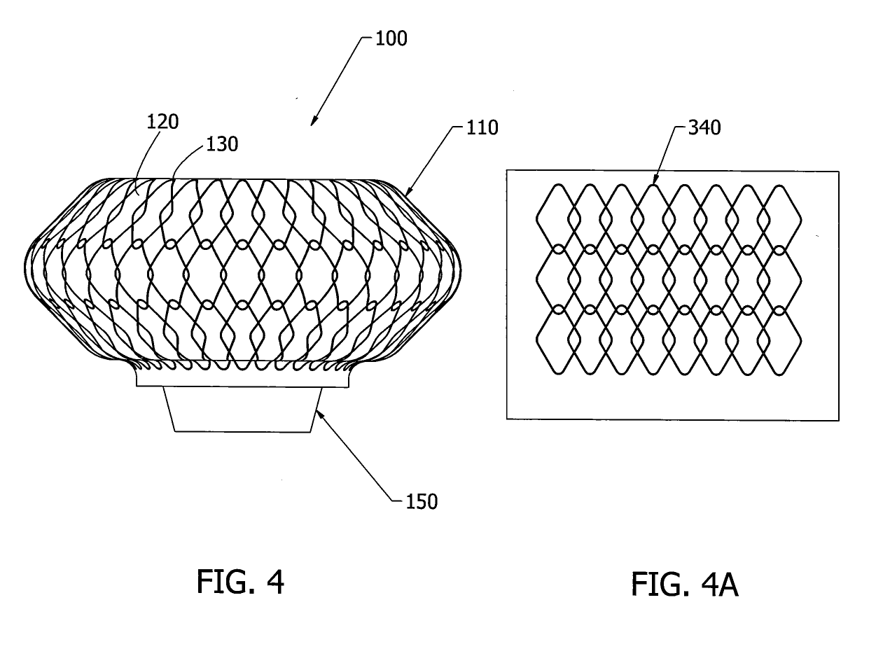

FIG. 4 illustrates an elevational view of an alternative embodiment of the improved tire curing bladder mold core's exterior surface 120 with grooves 130 formed therein in what is referred to as a diamond pattern 340. A stand alone example of said pattern 340 appears immediately to the right of said elevational view of the mold core 100 in FIG. 4A.

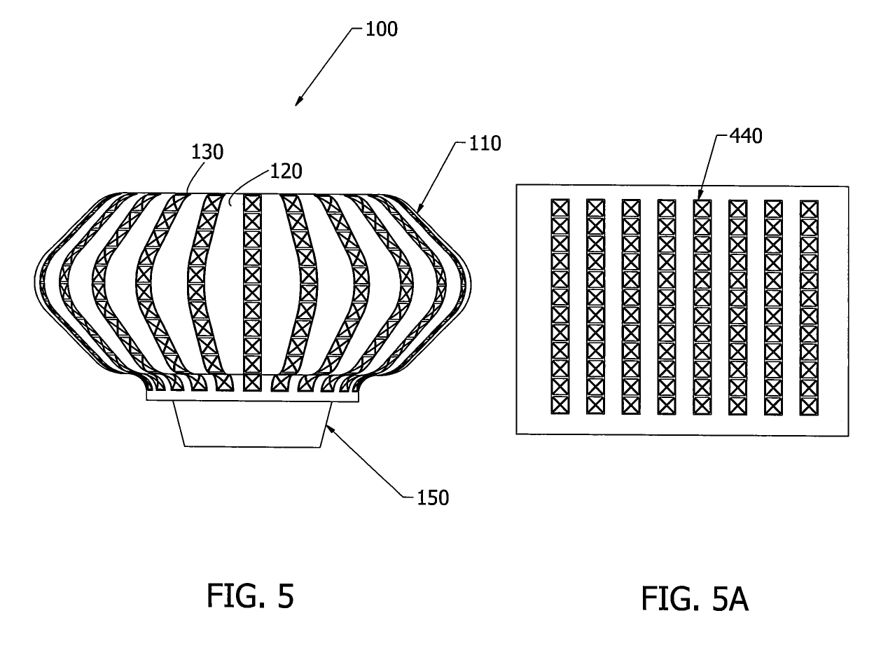

FIG. 5 illustrates an elevational view of an alternative embodiment of the improved tire curing bladder mold core's exterior surface 120 with grooves 130 formed therein in what is referred to as a grid with “X” pattern 440. A stand alone example of said pattern 440 appears immediately to the right of said elevational view of the mold core 100 in FIG. 5A.

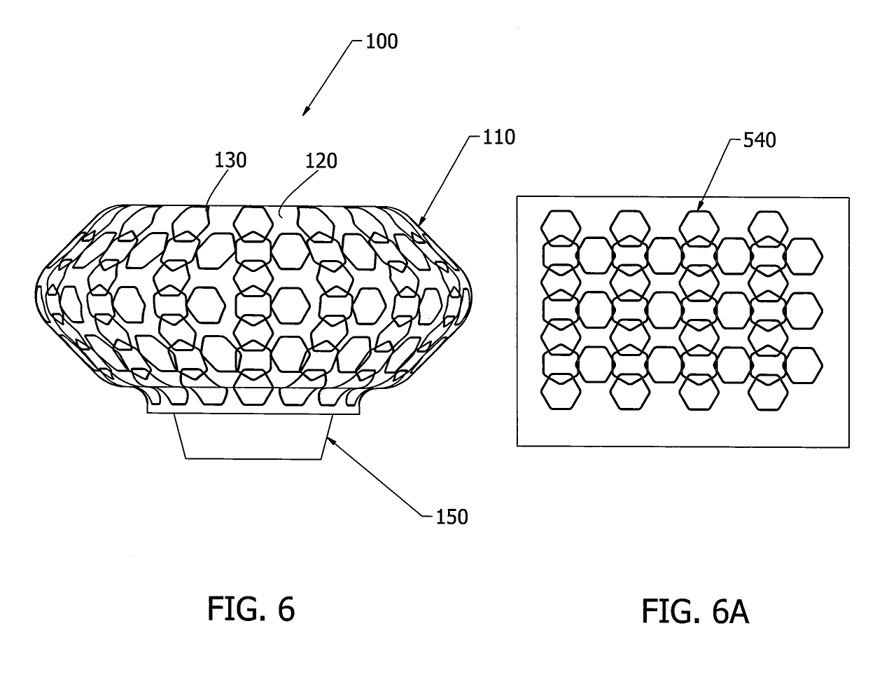

FIG. 6 illustrates an elevational view of an alternative embodiment of the improved tire curing bladder mold core's exterior surface 120 with grooves 130 formed therein in what is referred to as a polygon pattern 540. A stand alone example of said pattern 540 appears immediately to the right of said elevational view of the mold core 100 in FIG. 6A.

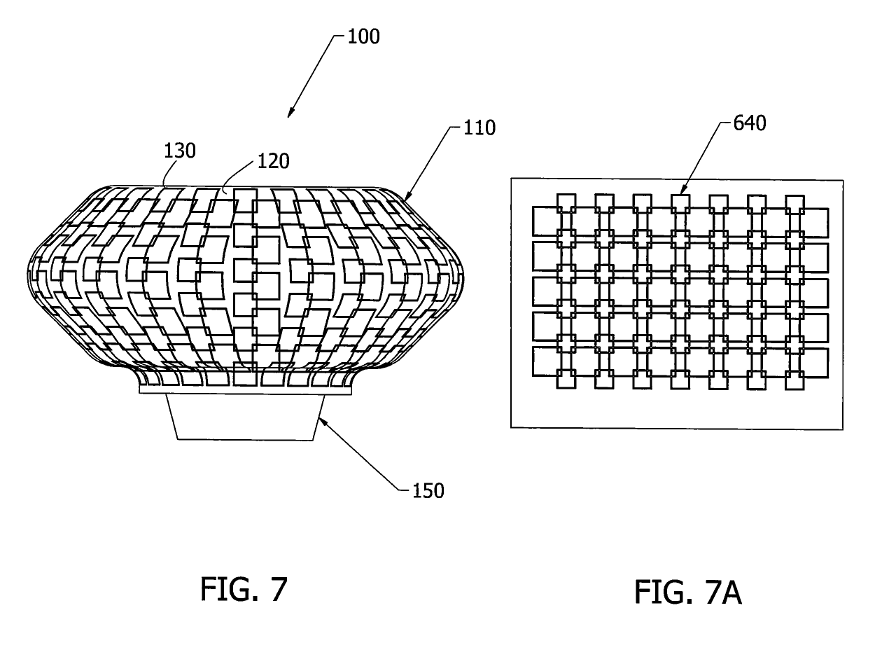

FIG. 7 illustrates an elevational view of an alternative embodiment of the improved tire curing bladder mold core's exterior surface 120 with grooves 130 formed therein in what is referred to as a square pattern 640. A stand alone example of said pattern 640 appears immediately to the right of said elevational view of the mold core 100 in FIG. 7A.

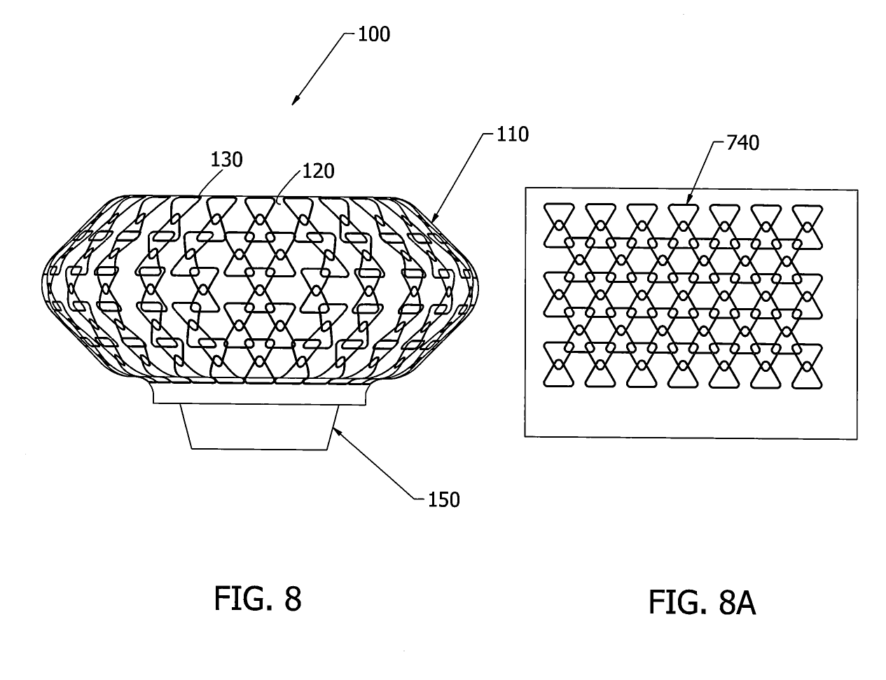

FIG. 8 illustrates an elevational view of an alternative embodiment of the improved tire curing bladder mold core's exterior surface 120 with grooves 130 formed therein in what is referred to as a triangle pattern 740. A stand alone example of said pattern 740 appears immediately to the right of said elevational view of the mold core 100 in FIG. 8A. Nonetheless, as previously mentioned, a number of other patterns 140 are also contemplated and the forgoing examples should not be construed as an exclusive listing of the various types of patterns 140 that can be utilized.

Having described the general structure of improved tire curing bladder mold core 100 of the present invention, its method of manufacture will now be described. A user (not shown) desiring to install a pattern 140 of grooves 130 along a portion of the exterior surface 120 of core portion 110 could accomplish the same via milling, such as CNC milling, chemical etching, or any other means commonly known in the art for installing a groove, etching or engraving on a metal surface. Nonetheless, in a preferred embodiment, the method may include one or more of the following steps: (1) transferring the desired groove pattern onto a 3 dimensional model of the mold core portion 110 of a curing bladder mold core 100, which may be accomplished using commercially available CAD/CAM software; (2) producing a G-code program and placing the mold core 100 onto a CNC 3 or 4-axis milling machine, which is also commercially available; and (3) milling the desired pattern onto the desired portions of the exterior surface 120 of core portion 110. As previously mentioned, grooves 130 are preferably between 0.02 and 0.6 inches deep, as measured from the bottom 132 of groove 130 to the exterior surface 120 of core portion 110, and comprise a radius of between 0.03 and 2 inches. Nonetheless, it is contemplated that other dimensions could also be employed to suit user preference or a particular application. Of course, the overall size and shape of grooves 130 will approximate the overall height and shape of the corresponding elevated ribs (not shown) formed in the internal surface of the tire curing bladder (also not shown), thereby improving the structural integrity of the tire curing bladder and minimizing the gage thickness required to avoid premature tire and/or bladder failure. Moreover, grooves 130 are preferably formed in a pattern 140 that is repeated along at least a portion of the exterior surface 120 of core portion 110.

Alternatively, instead of milling, the pattern 140 of grooves 130 may be chemically etched onto the desired portions of the exterior surface 120 of core portion 110. Additionally, if a chemical etching process is employed, a user can then hand bench the chemically etched grooves 130 with abrasives to provide rounded edges to said grooves 130.

Regardless of the method used (i.e., milling, chemical etching, etc.), the grooves 130 may also then be hand polished with abrasives to ensure optimal flow of rubber during the molding process. As previously mentioned, grooves 130 are utilized to create elevated support ribs (not shown) along the interior surface of a tire curing bladder (also not shown). The support ribs improve the structural integrity of the tire curing bladder, thereby enabling the same to have a thinner gage than that which would be otherwise required in the absence of said support ribs. Thinner gauged tire curing bladders require less material and translate into lower manufacturing costs and, therefore, are desirable provided that the structural integrity of the bladder and/or tire are cont compromised.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An improved tire curing bladder mold core comprised of:
a core portion with an exterior surface, wherein at least a portion of said exterior surface has grooves therein; and
a register portion.

2. The improved tire curing bladder mold core of claim 1, wherein said grooves form a pattern that is repeated along a portion of said exterior surface.

3. The improved tire curing bladder mold core of claim 1, wherein said grooves are between 0.02 and 0.6 inches deep.

4. The improved tire curing bladder mold core of claim 1, wherein said grooves further comprise a radius of between 0.03 and 2 inches.

5. The improved tire curing bladder mold core of claim 1, wherein at least a portion of said grooves are formed by milling.

6. The improved tire curing bladder mold core of claim 1, wherein at least a portion of said grooves are formed by chemical etching.

7. The improved tire curing bladder mold core of claim 1, wherein said grooves are randomly created.

8. A method for improving a tire curing bladder mold core comprised of a core portion with an exterior surface, said method comprising the step of:
forming grooves in at least a portion of the exterior surface of the core portion.

9. The method of claim 8 wherein at least a portion of said grooves are formed by milling which is comprised of the following steps:
transferring a desired pattern of the grooves onto a 3 dimensional model of the core portion;
producing a G-code program and placing the core portion onto a milling machine; and
milling the desired pattern onto at least a portion of the exterior surface of the core portion.

10. The method of claim 8 wherein at least a portion of said grooves are formed by chemical etching.

11. The method of claim 10 further comprising the step of hand benching said grooves with an abrasive.

12. The method of claim 9 further comprising the step of hand polishing said grooves with an abrasive.

13. The method of claim 10 further comprising the step of hand polishing said grooves with an abrasive.

14. The method of claim 8 wherein said grooves are between 0.02 and 0.6 inches deep.

15. The method of claim 8 wherein said grooves further comprise a radius of between 0.03 and 2 inches.

16. An improved tire curing bladder with an internal surface comprised of elevated support ribs formed on the internal surface of the tire curing bladder.

17. The improved tire curing bladder of claim 16 wherein said elevated support ribs form a pattern that is repeated along a portion of said internal surface.

18. The improved tire curing bladder of claim 16 wherein said elevated support ribs extend between 0.02 and 0.6 inches above the internal surface.

19. The improved tire curing bladder of claim 16 wherein said elevated support ribs have a radius of between 0.03 and 2 inches.

20. The improved tire curing bladder of claim 16 wherein said elevated support ribs strengthen said tire curing bladder.
